(19) United States
(12) Patent Application Publication
(10) Pub. No.: US 2015/0053889 A1
(43) Pub. Date: Feb. 26, 2015

(54) High-Power and High-Energy-Density Lithium Compound Solid-State Cathode

(71) Applicant: Brian O'Hunt Franklin, Fort Oglethorpe, GA (US)

(72) Inventor: Brian O'Hunt Franklin, Fort Oglethorpe, GA (US)

(21) Appl. No.: 13/974,343

(22) Filed: Aug. 23, 2013

(51) Int. Cl. H01M 4/36

(52) U.S. Cl. CPC H01M 4/364
USPC 252/182.1

(57) ABSTRACT

A solid-state (non-organic) high-power and high-energy-density cathode that is mechanically, thermally, and ionically robust.

### CROSS-REFERENCE TO RELATED APPLICATIONS

Not Applicable

### FEDERALLY-SPONSORED RESEARCH

Not Applicable

### SEQUENCE LISTING OR PROGRAM

Not Applicable

### BACKGROUND OF THE INVENTION

### Field of Invention

This invention relates to electrochemical power storage; specifically, a solid-state high-power and high-energy-density battery cathode.

### BACKGROUND OF THE INVENTION

Electrochemical power storage refers to batteries used to power electrical devices that typically are portable or otherwise not conveniently connected to a power-delivering grid.

Current technology has several limitations, including, but not limited to: limited service life, limited temperature range, environmental issues, detonation hazards, limited power storage, and high cost. The subject cathode of this application as a component of a secondary (rechargeable) battery overcomes the aforementioned current technology limitations.

### BACKGROUND OF INVENTION

### Objects and Advantages

Invention
(a) A cathode of significant internal and interface surface area by virtue of inclusion (internal) and high-aspect-ratio interface.
(b) Cathode material is thermally and structurally stable from subzero to elevated temperatures, both ends of the range being significantly beyond current technologies.
(c) The composition material is of high-ion-transfer inorganic chemistry.
(d) Inclusions (voids) are filled with additional but higher high-ion-transfer materials.
(e) No failure mode within the temperature range.
(f) No performance degradation vs. service life.
(g) Any kinetic offense (incident) results in 100% recyclability.
(h) Materials are benign unless specifically and intentionally abused.

Further features and advantages include greater scalability for purpose over current technology and broader appliance application, creating new portable devices.

### SUMMARY

Non-intuitive consideration came from cross-scientific and engineering field amalgamation and experience. This invention results from professional and necessary experience in a variety of technical disciplines largely centered on electrochemistry, physical chemistry, thin-film deposition techniques, inorganic chemistry, and photonics. This “bulk” cathode provides gravimetrically and volumetrically higher available- and transferable-ion capacity combined with the electrolyte facing cathode-enhanced surface area, giving enhanced power and energy density over the best currently available technology.

### DRAWINGS

### Figures (See Accompanying Drawings at End of Application)

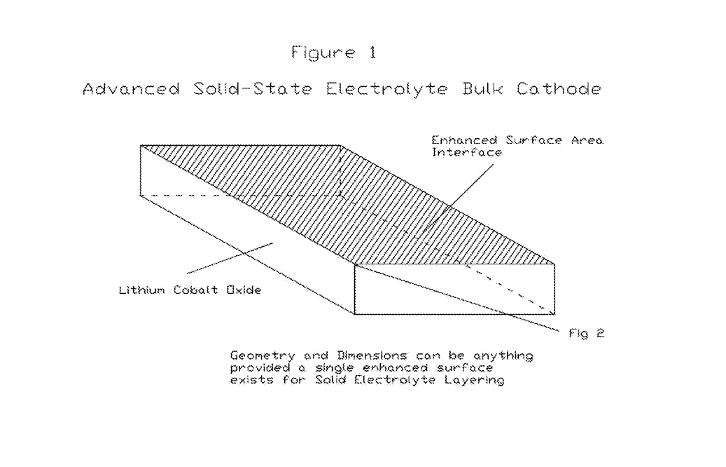

FIG. 1 shows a typical Advanced Solid-State Electrolyte Bulk Cathode geometry with associated Enhanced Surface Area Interface.

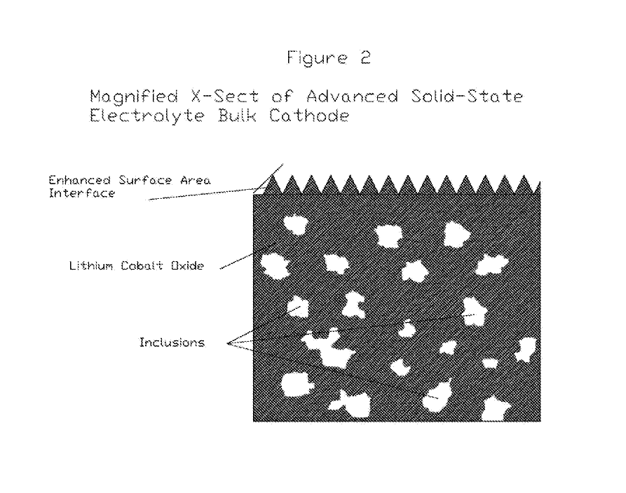

FIG. 2 shows a typical magnified cross section of the cathode, interstitial inclusions, and one potential geometric configuration for the enhanced surface area interface.

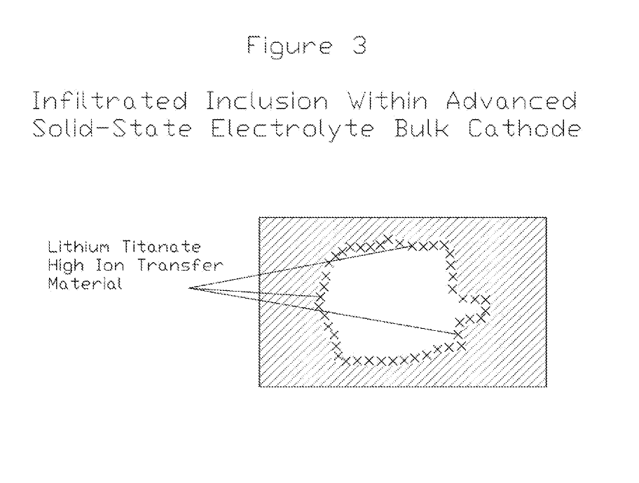

FIG. 3 shows a further magnified cathode inclusion after infiltration of the high ion transfer material—Lithium Titanate (LiTiO₂).

### DETAILED DESCRIPTION

### FIGS. 1-3—Preferred Embodiment

Powdered lithium cobalt oxide (LiCoO₂) is placed in a die of any geometry necessary for the specific application, designed with integrated high-aspect-ratio embossing, and pressed to 15,000 psi at between 600° C. and 800° C. in a Hot Isostatic Press (HIP). This process creates a solid pellet of stable, yet permeable, LiCoO₂ that requires no cutting or polishing as the basis for the cathode. The cathode is then infused with lithium-titanate (LiTiO₂) through Chemical Vapor Infiltration (CVI) using a suitable carrier gas.

### Advantages

From the descriptions above and the contrast with current cathode technology, several advantages become evident:
(a) A cathode of this structure and composition has significantly enhanced internal and interface surface area by virtue of inclusion (internal) and high-aspect-ratio interface;
(b) Cathode material is thermally and structurally stable from subzero to elevated temperatures;
(c) The composition material is of high-ion-transfer inorganic chemistry;
(d) No failure mode within the temperature range;
(e) No performance degradation vs. service life;
(f) Damaged cathodes result in 100% recyclability.
(g) Materials are benign unless specifically and intentionally abused.

Further objects and advantages include greater scalability for purpose over current technology and broader appliance application creating new portable devices.

### REFERENCES

1. “Development of Low Temperature Lithium-ion Electrolytes for NASA and DoD Applications”, E. J. Plichta, M. Hendrickson, R. Thompson, G. Au, W. K. Behl, M. C. Smart, B. V. Ratnakumar and S. Surampudi, J. Power Sources, 94 (2), 160, (March 2001).
2. “Low Temperature Performance of Graphite Electrode in Lithium-ion Cells”, S.S. Zhang, K. Xu and T. R. Jow, Electrochimica Acta, 48 (13), 241 (2002).
3. “A High-Voltage, Solid-State Battery System”, by C. C. Liang, J. Epstein and G. H. Boyle, J. Electrochem. Soc., 116, 1452 (1969).
4. “Lithium Oxide -Based Amorphous Ionic Conductor”, M. Katsuki, K. Kanehori and T. Kudo, European Patent Application (1984).
5. “ Fast Li⁺ ion Conduction in Li₂O—(Al₂O₃ Ga₂O₃)—TiO₂—P₂O₅ Glass Ceramics”, J. Fu, J. Mater. Sci., 33 (6), 1549 (1998).
6. “Technique for Monitoring Densification During Chemical Vapor Infiltration Processing of Composites”, W. J. Lackey, S. Vaidyaraman, G. B. Freeman, and P. K. Agrawal, J. American Ceramic Soc., 78 (4), 1131 (1995).
7. “A Two-Dimensional Model of Chemical Vapor Infiltration with Radio Frequency Heating II: Strategies to Achieve Complete Densification”, V. Midha and D. J. Economou, J. Electrochem. Soc., 145 (10), 3569 (1998).
8. “TEM Study of Electrochemically Cycling-Induced Damage and Disorder in LiₓCoO₂ Cathodes for Rechargeable Lithium Batteries”, H. Wang, Y. I. Jang and B. Huang, J. Electrochem. Soc., 146, 473 (1999).
9. “Electrical Conductivity of Silver Sulfide”, by M. H. Hebb, J. Chem. Phys., 20, 185 (1952).
10. “Galvanische Zellen mit festen Elektrolyten mit gemischter Stromleitung”, by C. Wagner, Z. Elektrochem., 60, 4 (1956).
11. “Ionic Conductivity of Lithium-oxide based Mixed Oxides and the Effect of Moisture and LiOH on their Electrical and Structural Properties”, R. M. Biefeld and R. T. Johnson, Jr., J. Electrochem. Soc., 126, 1 (1979).
12. “Electrochemical Studies of Lithium Nitride Solid Electrolyte for Electrochromic Devices”, by M. Miyamura, S. Tomura, A. Imai and S. Inomata, Solid State Ionics, 3/4, 149 (1981).
13. “Elaboration and Characterization of Lithium Conducting Thin Film Glasses”, by A. Levasseur, M. Kbala, P. Hagenmuller, G. Conturier and Y. Danto, Solid State Ionics, 9&10, 1439 (1983).
14. “Thin Film Solid Electrolyte and its Application to Secondary Lithium Cell”, by K. Kanehori, K. Matsumoto, M. Miyauchi and T. Kudo, Solid State Ionics, 9&10, 1445 (1983).
15. “Titanium Disulfide Films Fabricated by Plasma CVD”, by K. Kanehori, Y. Ito, F. Kirino, M. Miyauchi and T. Kudo, Solid State Ionics, 18&19, 818 (1986).
16. “Preparation of Fast Lithium Ion Conducting Glasses in the System Li₂S—SiS₂—Li₃N”, by R. Sakamoto, M. Tatsumisago and T. Minami, J. Phys. Chem. B, 103, 4029 (1999).
17. “Proceedings of the Symposium on Lithium Batteries”, edited by S. Surampudi and R. Marsh, Proceedings Volume 98-16, The Electrochem. Soc., Inc., Pennington, N.J. (1999).
18. “Batteries: Full Speed Ahead”, by G. Ondrey, C. Crabb and T. Kamiya, Chem. Eng., 106 (2), 47 (February 1999).
19. “A New Cathode Material for Batteries of High Energy Density”, by K. Mizushima, P. C. Jones, P. J. Wiseman and J. B. Goodenough, Mater. Res. Bull., 15, 783 (1980).
20. “Electrode Materials for Lithium Ion Rechargeable Batteries”, by T. Nagaura, Proc. of the 5^{th} Intl. Seminar on Lithium Battery Technology and Applications, Deerfield Beach, Fla., March 1990.
21. “Discharge Rate Capability of the LiCoO₂ Electrode”, by K. M. Abraham, D. M. Pasquariello and E. M. Willstaedt, J. Electrochem. Soc., 145, 482 (1998).
22. “LiAl_{y}Co_{1-y}O₂ (R3m) Intercalation Cathode for Rechargeable Lithium Batteries”, by Y. I. Jiang, B. Huang and H. Wang, J. Electrochem. Soc., 146, 862 (1999).
23. “Electronic Conductivity of LiCoO₂ and its Enhancement by Magnesium Doping”, by H. Tukamoto and A. R. West, J. Electrochem. Soc., 144, 3164 (1997).
24. “Changes in Structure and Cathode Performance with Composition and Preparation Temperature of Lithium Cobalt Nickel Oxide”, by R. Alcantara, P. Lavela and J. L. Tirado, J. Electrochem. Soc., 145, 730 (1998).
25. “Mechanochemical Synthesis and Electrochemical Properties of LiMn₂O₄”, by H. J. Choi, K. M. Lee and G. H. Kim, J. Am. Ceram. Soc., 84, 242 (2001).
26. “Design Considerations for Lithium-ion Cells. Part I: Cell Components”, by M. W. Juzkow and S. T. Mayer, The Twelfth Annual Battery Conference on Applications and Advances, California State University, Long Beach, Calif., January 1997.
27. “Characterization of Thin Film Rechargeable Lithium Batteries with Lithium Cobalt Oxide Cathodes”, by B. Wang, J. B. Bates and F. X. Hart, J. Electrochem. Soc., 143, 3203 (1996).
28. “Scaling Laws in Annealed LiCoOₓ Films”, by M. U. Kleinke, J. Polo-da-Fonseca, C. Davalos and A. Gorenstein, Appl. Phys. Lett., 74, 1683 (1999).
29. “Preparation and Characterization of LiCoO2 Thin Films by Laser Ablation Deposition”, M. Antaya, J. R. Dahn and J. S. Preston, J. Electrochem. Soc., 140, 575 (1993).
30. “Electrochromic Properties of Lithiated Co-oxide (LiₓCoO₂) and Ni-oxide (LiₓNiO₂) Thin Films Prepared by the Sol-Gel Route”, F. Svegl, B. Orel and V. Kaucic, Solar Energy, 68, 523 (2000).
31. “Preparation of Binder-Free, Thin Film LiCoO₂ and its Electrochemical Responses in a Propylene Carbonate Solution”, I. Uchida and H. Sato, J. Electrochem. Soc., 142, L139 (1995).
32. “Unique Porous LiCoO₂ Thin Layers Prepared by Electrostatic Spray Deposition”, by C. H. Chen, E. M. Kelder and J. Schoonman, J. Mater. Sci., 31, 5437 (1996).
33. “In-Situ Conductivity Measurements of LiCoO₂ Films During Lithium Insertion/Extraction by Using Interdigitated Microarray Electrodes”, by M. Shibuya, T. Nishina and T. Matsue, J. Electrochem. Soc., 143, 3157 (1996).
34. “Rechargeable Thin-Film Lithium Batteries” by J. B. Bates, G. R. Gruzalski, N. J. Dudney, C. F. Luck, and X. Yu, Solid State Ionics, 70/71, 619 (1994).
35. “Electrochemical Properties of Low Temperature Crystallized LiCoO₂”, by B. Garcia, J. Farcy and J. P. Pereira-Ramos, J. Electrochem. Soc., 144, 1179 (1997).
36. “Atomic Layer Epitaxy”, by C. H. L. Goodman and M. V. Pessa, J. Appl. Phys., 60, R65 (1986).
37. “Atomic Layer Deposition for Nanoscale Thin Film Coatings”, by B. Pathangey and R. Solanki, Vacuum Technol. and Coating, p. 33 (May 2000).
38. “Characterization of Surface Exchange Reactions Used to Grow Compound Films”, by M. Pessa, R. Mäkelä and T. Suntola, Appl. Phys. Lett., 38, 131 (1981).

1. A pressed and sintered matrix of porous Lithium Cobalt Oxide with enhanced surface area interface and infused with Lithium Titanate.
